(19) United States
(12) Patent Application Publication
(10) Pub. No.: US 2010/0076786 A1
(43) Pub. Date: Mar. 25, 2010

(54) Computer System and Computer-Implemented Method for Providing Personalized Health Information for Multiple Patients and Caregivers

(75) Inventors: William S. Dalton, Temple Terrace, FL (US); Paul Jacobsen, Tampa, FL (US); David A. Fenstermacher, Tampa, FL (US)

Correspondence Address: FISH & RICHARDSON P.C., PO BOX 1022, MINNEAPOLIS, MN, 55440-1022, US

(73) Assignees: H.LEE MOFFITT CANCER CENTER AND RESEARCH INSTITUTE, INC., Tampa, FL (US); UNIVERSITY OF SOUTH FLORIDA, Tampa, FL (US)

(21) Appl. No.: 12/537,126

(22) Filed: Aug. 6, 2009

Related U.S. Application Data
(60) Provisional application No. 61/086,649, filed on Aug. 6, 2008.

(51) Int. Cl. G06Q 50/00; G06Q 10/00; G06F 17/30

(52) U.S. Cl. 705/3; 705/2; 707/780; 707/E17.06

(57) ABSTRACT

Personalized health information is provided by maintaining a patient profile over time and matching information from the patient profile to appropriate patient-centric information related to that patient's specific medical condition. The patient profile can include a variety of medical information. The patient profile is matched, for example, to patient-centric options for care, clinical trials for which the patient is eligible, drug treatment regimens directly related to each patient's specific condition, scheduling of the treatments, survivorship plans and data, information about managing symptoms, nutritional information, rehabilitation recommendations, possible adverse events based on specific treatments to monitor, and personalized education and information. The patient profile can be populated with information from a database, such as one associated with a cancer registry.

### RELATED APPLICATION

This application claims the benefit of priority from U.S. Provisional Application No. 61/086,649, filed Aug. 6, 2008, which provisional application is incorporated by reference herein in its entirety.

### BACKGROUND

The provision of health care related information over publicly accessible computer systems, such as the Internet, is generally limited to a few kinds of activities. These activities include: access to personal health records; scheduling appointments, registration and bill payment; secure messaging with service providers; access to general health information such as current medications. In other words, most current systems provide general information and basic transactions.

Access to personal health records, scheduling appointments, registration and bill payment typically is provided through password protected accounts accessed over the Internet. Secure messaging with service providers also may include password protected accounts that a user may access over the Internet. After logging in, a user can send and receive electronic mail, text messages, or instant messages to and from service providers.

Access to general health information typically is provided through web sites accessed over the Internet that provide health care information relating to certain types of disease or populations of patients. For example, one may access a cancer survivors' network, which provides discussion groups and a resource library. The information provided typically is generic for all users and is disease-centric.

### SUMMARY

General information and basic transactions are not specific enough to each patient to fulfill the needs of patients and their caregivers. Personalized health information is provided by maintaining a patient profile over time and matching information from the patient profile to appropriate patient-centric information related to that patient's specific medical condition. The patient profile includes a variety of medical information, including, but not limited to medical history, diagnostic information, prognostic information, survivorship plan, current treatment regimens and possibly genetic information. The patient profile is personalized, in that it contains not only historical information related to the patient and patient's care, but also information that is matched to the patient based on past, current and/or future care. The patient profile is matched, for example, to patient-centric options for care, clinical trials for which the patient is eligible, drug treatment regimens directly related to each patient's specific condition, scheduling of the treatments, survivorship plans and data, information about managing symptoms, nutritional information, rehabilitation recommendations, possible adverse events based on specific treatments to monitor, and personalized education and information to name a few.

Because the patient profile is updated and modified over time, as the patient receives care, experiences and reports symptoms and outcomes of care using electronic interfaces or clinical visits, the personalized health information is updated periodically. Therefore, the patient or caregiver receives up to date personalized health information when the information is accessed. For example, a patient may report symptoms, which in turn can be used to access recommendations for managing those symptoms in the context of the rest of the patient's medical condition, history and treatment regimen. Patient responses to questionnaires, which facilitate the integration of valuable data from multiple health care providers, also may prompt recommendations for lifestyle modifications or different medicines and treatments.

### DESCRIPTION OF DRAWINGS

FIG. 1 is a data flow diagram of an example computer system that provides personalized health information for multiple patients and caregivers.

FIG. 2 is a data flow diagram illustrating an alternative implementation of the computer system in FIG. 1.

FIG. 3 is a data flow diagram illustrating another alternative implementation of the computer system in FIG. 1.

FIG. 4 is a more detailed block diagram of how patient data may be consolidated from multiple sources to provide the patient database of FIG. 1.

FIG. 5 shows one example of a survivorship user interface associated with a portal.

FIG. 6 shows one example of another user interface associated with a portal.

FIG. 7 shows an example method for personalizing data provided to a patient.

FIG. 8 shows an example method for providing a survivorship plan to a patient.

FIG. 9 shows an example method for populating a profile.

### DETAILED DESCRIPTION

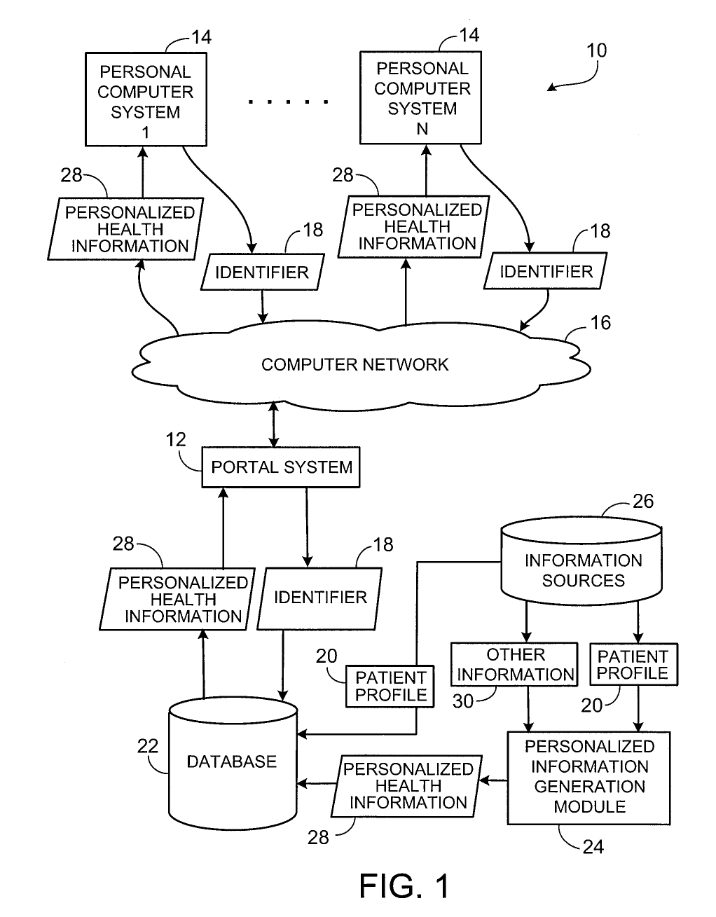

Referring now to FIG. 1, a computer system 10 provides personalized health information to multiple patients, or their caregivers or other person authorized by the patient. Unless otherwise stated herein, the various functions described as being performed in connection with this computer system 10 are performed by one or more computers or processors in or associated with the computer system.

The computer system 10 includes a portal computer system 12, through which multiple patients (or caregivers) request access to patient-specific information. Each patient, or caregiver, may access the portal computer system 12 through, for example, a personal computer system 14 over a publicly accessible computer network 16 such as the Internet. The computer system 10 can be represented as a computer network and typically includes multiple computers that are logically connected through a variety of communication channels, whether wired or wireless, and that communicate using standard computer network communication protocols such as TCP/IP, UDP and/or HTTP.

When accessing the portal computer system 12, the personal computer system 14 transmits a unique identifier 18 assigned to the patient. This unique identifier 18 is used by the portal computer system 12 to cause information about the patient, in particular personalized health information 28, to be retrieved from a database 22. The database 22 stores, for each patient (as indicated by the unique identifier 18 for the patient), personalized health information 28 for the patient, which also may include information such as the patient profile 20 or other helpful information. The portal computer system 12 transmits at least a portion of this personalized health information 28 to the personal computer system 14. In some implementations, the information provided is limited according to the authorization level for the user, e.g., according to whether the user is the patient, the patient's doctor, some other caregiver for the patient, or other authorized person. It should be understood that the database 22 in FIG. 1 may be implemented using multiple databases, but is shown as a single database in FIG. 1 for ease of illustration only.

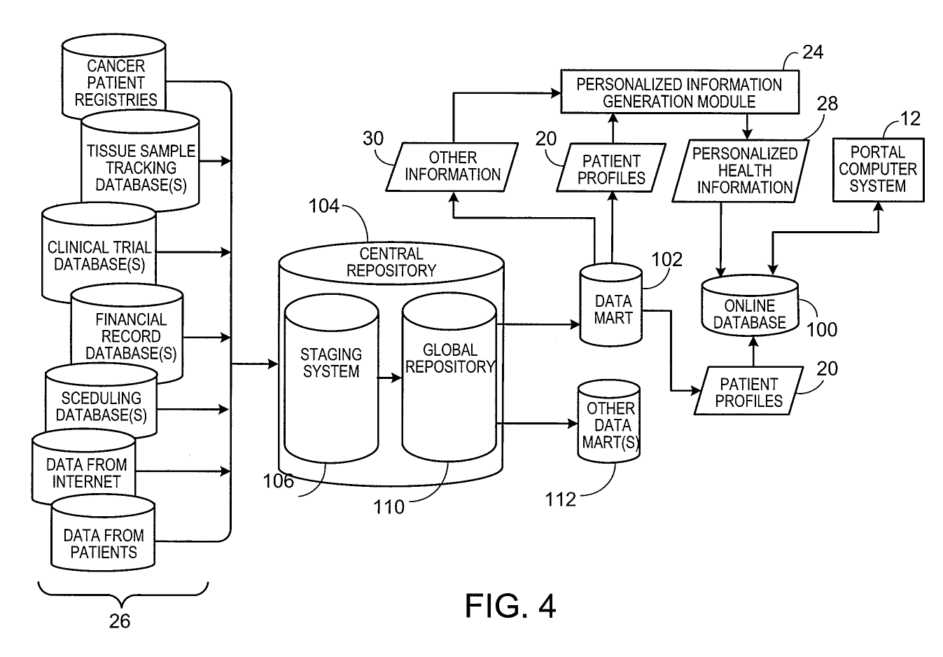

To generate the personalized health information 28, a personalized information generation module 24 uses a patient profile 20 and other information 30 from information sources 26. The personalized health information 28 is stored in the database 22 by module 24. Information from a patient profile 20 also may be stored directly in the database 22. The generation of personalized health information 28 will be described in more detail below in connection with FIG. 4.

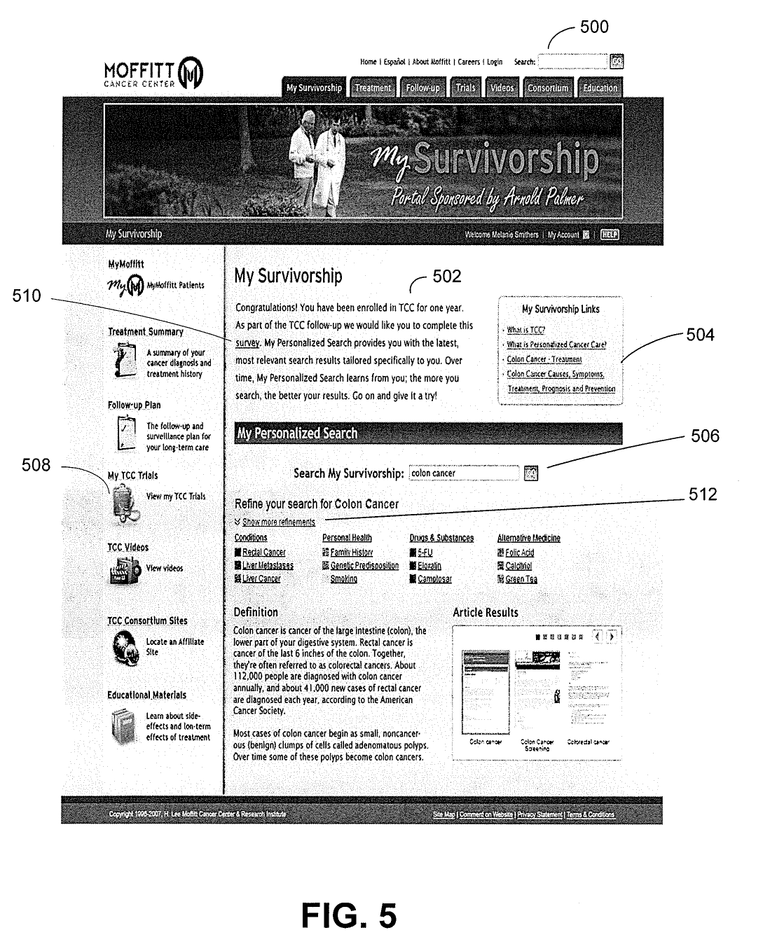

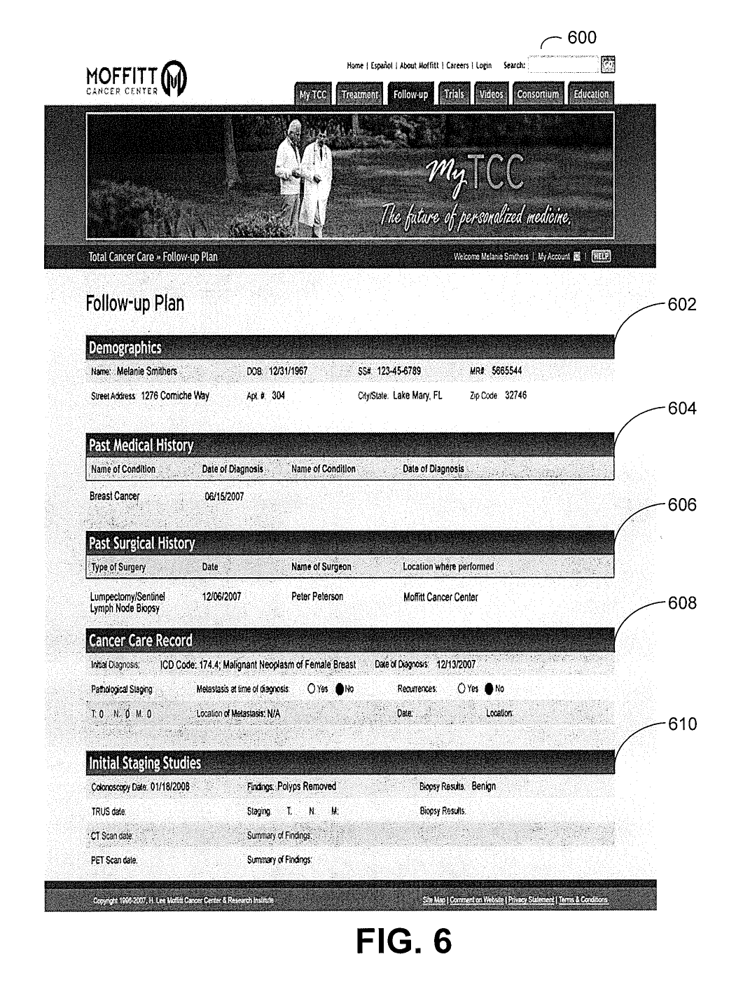

In one example, the personal computer system 14 is a general-purpose computer with a connection to the Internet and includes at least a display and web browser software. The web browser software contacts the portal computer system 12 and receives from the portal computer system 12 a main document (e.g., a domain top level document), which may be in hypertext markup language (HTML), extensible markup language (XML) or other web browser compatible format, through which a user may log into the portal computer system 12 using a username and password. After the personal computer system 14 submits the username and password to the portal computer system 12, the portal computer system 12 provides the personalized health information 28 to the patient through the personal computer system 14. Examples of user interfaces provided after authentication are shown in FIGS. 5 and 6. The personalized health information 28 can be of the form of a hypertext markup language (HTML) documents, extensible markup language (XML) documents or other web browser compatible formatted information. Display data within the browser may also be generated using Java, JavaScript, Python, or Ruby, for example, and is displayed on the monitor of the personal computer system 14.

The portal computer system 12, in one example, is a general purpose server computer configured to run web server software and interface software enabling it to connect to database 22 and the Internet.

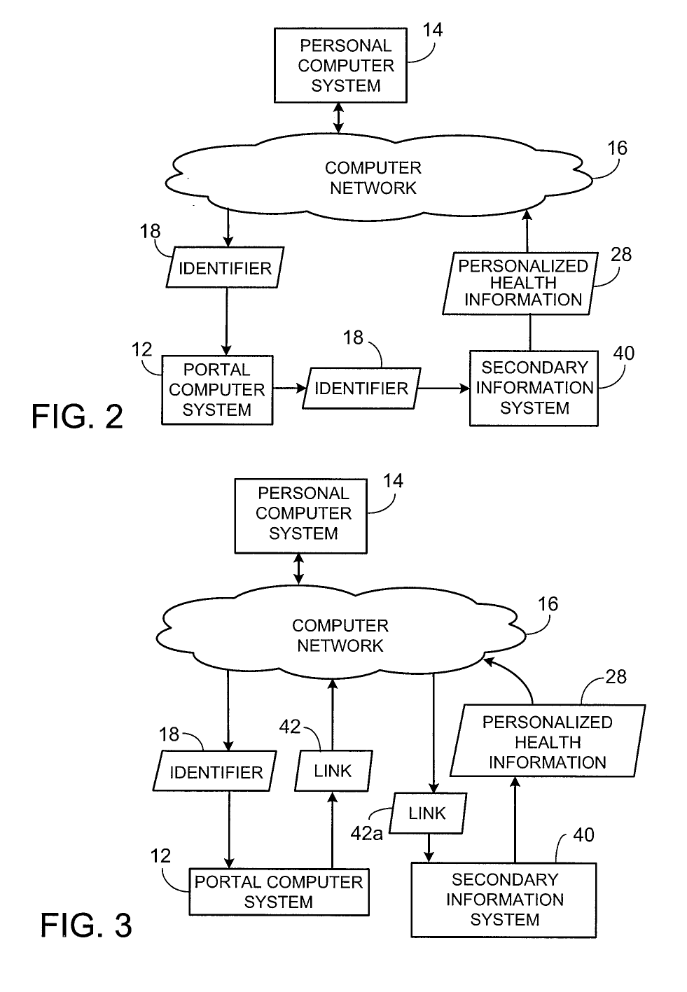

Although FIG. 1 illustrates a portal computer system 12 that provides the personalized health information 28 directly from the database 22, another example implementation includes a secondary information system 40 accessed by the portal computer system 12, such as shown in FIG. 2. The portal computer system 12 provides the identifier 18 to the secondary information system 40. The secondary information system in turn retrieves the personalized health information 28 from a database (not shown), and provides it to the personal computer system.

As another example implementation shown in FIG. 3, the portal computer system 12 may provide the personal computer system 14 with a link 42 that identifies a secondary information system 40 and data for instructing it to access the personalized health information 28 for that patient. The personal computer system 14 receives the link 42 and provides the data 42a to the secondary information system 40, instructing it to retrieve and provide the personalized health information 28 from a database (not shown). Other implementations in which the portal computer system 12 causes the personalized health information 28 to be transmitted to the personal computer system 14 can be used.

FIG. 1 illustrates an example implementation of computer system 10 in which the personalized health information 28 is generated and then stored in the database 22. The personalized health information 28 can be initially generated as described below by evaluating a personal profile 20 and other information. Personal profile generation is described in greater detail below in association with FIG. 10. The personalized health information 28 can be developed based on a matching process as will be described in greater detail below in association with FIG. 4. The personalized health information 28 can then be stored (e.g., in database 22 or secondary information system 40) for later retrieval by the patient, caregivers or other authorized individuals. After initialization, the personalized health information 28 can be retrieved (e.g., from database 22) when the patient accesses the portal computer system 12. The personalized health information 28 can be updated overtime. In some implementations, the personalized information generation module 24 periodically accesses information sources 26, and systematically generates, for each patient, appropriate updates to the personalized health information 28 for that patient and stores the updated information in the database 22. For example, at the end of each business day, the computer system can be configured to perform this update. Thus, all changes to information in or associated with a patient profile 20 made that day can be reflected in the personalized health information 28 for that patient by the next day. Updates can be configured not only based on changes to the patient profile 20, but made periodically irrespective of changes to the profile. For example, the matching process to locate additional personalized information (i.e., augmented information) can be performed periodically to ensure that current information is made available to the patient.

In another example implementation, the personalized information generation module 24 can generate the personalized health information 28 in response to the patient accessing the portal computer system 12, in which case the module 24 would receive a unique identifier 18 for that patient to enable it to access a patient profile 20.

The patient profile 20 includes, for example, medical information related to medical history, diagnostic information, prognostic information, treatment regiment, and optionally genetic information for each patient. The patient profile 20, for example, may include information about a patient's genetic disposition to disease, demographics, lifestyle choices, and molecular profiles related to specific diseases of the patient. Other examples of medical information that may be included in a patient profile 20 include, but are not limited to: an electronic medical record, including diagnoses, treatments, prognoses, medicines, lab results and outcomes of care; surgical data, including procedures and timelines; survey information including demographics, history, screening and risk assessment; portions of a cancer registry, including follow-up information, diagnosis and vital status; pathology information including typing information; tissue samples and other biospecimen information, including location, diagnosis, preparation and type; clinical trial data, including protocols, studies and participation; operational data, including billing, scheduling and visit information; and microarray data, including gene expression, experiment analysis and sequence verified annotation; prescriptions written and fulfilled; vital signs; and physician's notes.

The patient profile 20 can be enhanced through directed questionnaires and symptom reports completed by each patient, or a caregiver. For example, a patient or caregiver may report symptoms using a form presented to the user via the personal computer system 14. Various forms can be presented as part of a survivorship plan at times in accordance with a patient's condition/treatment in order to augment the patient profile 20. As another example, in some instances, the generation of personalized health information 28 may require information from the patient that is not in the patient profile 20. A patient or caregiver may be prompted to complete a questionnaire, using a form presented to the user via the personal computer system 14. When such a form is completed it is submitted to the portal computer system 12, which in turn provides data to an appropriate clinician or clinical data system for storage. The information from the form can be included in the patient profile 20.

FIG. 5 shows an example of a user interface 500 associated with survivorship. Survivorship refers to that combination of resources that are presented to the user as part of the portal that are directed to continued medical follow-up for patients after diagnosis with emphasis on the basic standards of care that include the specific needs of long-term survivors along with information, plans, programs and tools that focus on health promotion, disease prevention, recurrence prevention, rehabilitation, and the identification of physiologic and psychosocial problems. A survivorship plan while including basic follow up information after a specific treatment augments the treatment plan for an individual. Interface 500 includes an information area 502, links 504, search area 506 and tools 508 among other controls (not labeled). Information area 502 provides general information on survivorship and may include one or more prompts 510 to augment information in the system so that personalized results can be provided. Links 504 include general and personalized links that are associated with the patient condition/treatment plan/past care, etc. Search area 506 includes a search bar for receiving queries from a user. Queries can be evaluated against general and specific search databases to provide personalized search results. Search area 506 can include one or more refinement tools 512. Refinement tools 512 can be used to narrow search results to, for example, particular conditions, personal health considerations, alternative medicines, etc. Search area 506 can be associated with a search engine that maintains historical search information related to user queries. The historical search information can be used to augment or otherwise modify search results that are returned based on previous queries. For example, a search by a user directed to specific treatment plans for a patient with diabetes might be retained and used to provide future search results that are directed to patients with diabetes. Tools 508 can provide links in the portal to other interfaces, such as to a treatment summary page, follow-up plan page, clinical trials page or other materials or resources.

FIG. 6 shows an example of a user interface 600 associated with the portal. Interface 600 includes data areas including demographics area 602 including a demographics summary, past medical history area 604, past surgical history area 606, cancer care record area 608, and initial staging studies area 610.

Other user interfaces are possible.

Returning now to FIG. 4, an example of how a patient profile may be generated and stored in the database 22 using multiple information sources will now be described. Database 22 (FIG. 1) may be implemented using an online database 100, which receives data from a datamart 102 and the personalized information generation module 24. The datamart 102 stores patient data from which data is extracted, aggregated and/or transformed to provide patient profiles 20 in the online database 100. Datamart 102 can be located behind a firewall (not shown) that prevents computer network traffic from the Internet from accessing the datamart 102. Data is periodically extracted, copied, aggregated and transformed from the datamart 102 to provide data to the online database 100. Also, the personalized information generation module 24 obtains information, such as the patient profiles 20 and other information 30 and stores the personalized health information 28 it generates in the online database 100. The portal computer system 12 in FIG. 1 uses the online database 100 to respond to requests for data.

The datamart 102 can be created by combining patient data from the variety of sources that have patient data, because there are generally multiple sources of patient data for each patient. This combination can be performed using a centralized repository 104 that includes a staging system 106, which periodically copies, cleanses, aggregates and transforms data from information sources 26 into the staging system 106. A global repository 110 periodically is updated with correctly formatted and quality-verified data from the staging system 106. The other sources 108 of data may include, but are not limited to, cancer patient registries of institutions or agencies, tissue sample tracking database, clinical trial databases (such as those provided by the caBIG® (Cancer Biomedical Informatics Grid) network at the National Institutes of Health), electronic medical record databases, financial record (billing and payment) databases, scheduling databases, and other health information systems such as those provided by Galvanon, Inc., Cerner Corporation and others. Some of these sources can be of the form of clinical information systems for which clinical data is entered by clinicians and/or other staff of a health care provider. Data also may come from resources (e.g., the Internet) and from patients. In some implementations, any patient-provided data is not supplied to the online database 100 but instead is placed first into one or more of the clinical data systems (part of information sources 26) that provide data to the central repository 104. In some implementations, the patient profile 20 is generated substantially from information sources and not from the patient directly. The global repository 110 provides a stable representation of the combined patient data. In some implementations, the patient and patient related data is extracted from global repository 110 into datamart 102 on periodic cycles that make the patient data available to other computing resources (e.g., the personalized information generation module 24 or portal computer system 12). As described above, the patient data is accessed through portal computer system 12 when proper authentication is provided by the personal computer system 14. Other datamart(s) 112 also may periodically extract data from the global repository 110.

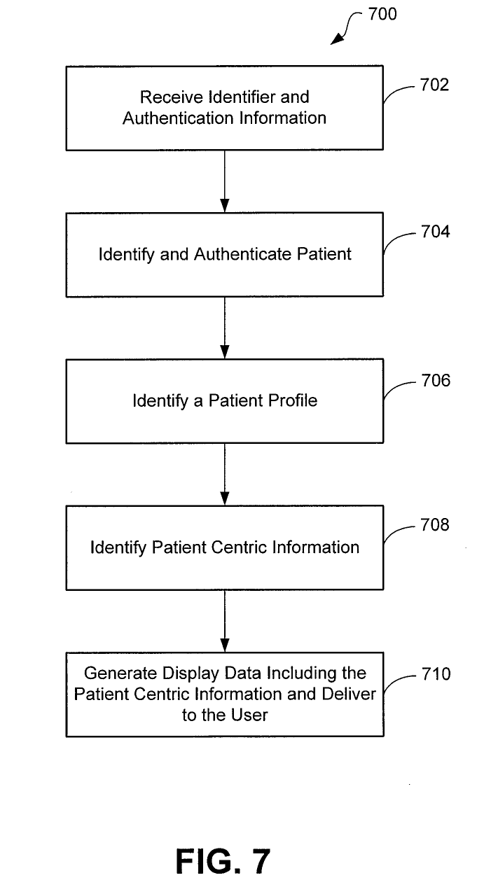

Having now described the architecture of an example computer system for providing personalized data to a patient, caregiver or other authorized entity, the generation of personalized health information will now be described. Generation of personalized data includes two parts, matching and retrieving information. Referring now to FIGS. 1 and 7, an example method 700 for providing personalized information is described. At stage 702, an identifier is received along with authentication information from a user. For example a user can navigate to a top level domain associated with a personalized information provisioning service and provide a unique user identifier using the personal computer system 14. At stage 704, a patient is identified and authenticated. For example, portal computer system 12 can receive the unique user identifier and authentication information and determine if the user is authorized to access the patient information. If no authentication occurs, the process can end.

At stage 706 a patient profile is identified. The patient profile can be of the form of a record that is stored in database 22. In some implementations, the patient profile 20 is a record stored in the global repository 110. At stage 708, patient centric information is identified. In some implementations, the patient centric information has been previously stored in or associated with the patient profile 20. In some implementations, the patient centric information is developed in real time based on other information in the patient profile 20 (i.e., the personalized information generation module 24 can generate in real time information for use in populating one or more pages to be returned to the user in response to the login operation). Whether in real time or cached, information in the patient profile 20 is matched to appropriate patient-centric information related to that patient's specific medical condition to provide the personalized health information 28. The personalized health information 28 may include options for care, clinical trials for which the patient is eligible, drug treatment regimens directly related to each patient's specific condition, scheduling of the treatments, survivorship plans and data, information about managing symptoms, nutritional information, rehabilitation recommendations, possible adverse events based on specific treatments, and personalized education and information, all related to that patient's specific medical condition. This matching of information from a patient profile to provide personalized health information 28 may be implemented in many ways, depending on the type of personalized health information 28.

As one example, a decision tree may be built for each type of personalized health information 28 that may be provided. Each node in the decision tree can be based on information in a patient profile. If information required by a decision tree is not available in the patient profile, the patient or caregiver may be prompted for the information. A decision tree can be represented in computer software and be applied to input data (in this example, medical information from a patient profile) when that computer software is executed by a computer to provide the outputs of the decision tree (in this case, the relevant personalized health information).

Instead of a decision tree, other computational models that map multiple inputs to personalized health information 28 may be used, such as neural networks, Markov processes, support vector machines, or other probabilistic models. The use of decision trees in some cases may be preferable because the reasoning behind results of a decision tree may be more easily explained than the results provided by probabilistic models.

An appropriate decision tree, or other computational model, may be built by analyzing actual patient data using a form of clustering analysis by a computer, by using expert opinion, by using results of reported studies, or any combination of these. An example of clustering analysis includes, but is not limited to, classification and regression trees. Clustering analysis can be performed using data in the database 22 (or any of the data warehouses shown in FIG. 4) or other data from other sources. For example, clustering analysis can be performed on data that also includes outcomes of treatment, comorbidity data and survivorship data. Clustering analysis determines what information in the patient profile 20 is relevant to classifying patients into different groups, such that each group is provided with different information. Patients in each group are given different personalized health information 28, based on the information in their patient profiles 20 that distinguish them from other groups of patients. In some implementations, the matching process includes a matching of information from a patient profile to one or more of a plurality of pre-defined groups. The groups can represent broad and narrow classifications that are specific to a patients existing condition, past treatment, future care plan or other criteria to name a few examples. Information may be associated with each group, resulting in a delivery of the group information to the user based on the matching process.

In some implementations, by including, in the clustering analysis, information about outcomes of treatment, comorbidity data and survivorship data, a group of similar patients may be further classified by their treatment regimens, by distinguishing treatments that worked from treatments that did not work. A patient that is otherwise similar to one group of patients may be recommended for treatment that has been identified to work for similar patients. Alternatively, if a patient that is similar to one group of patients and is receiving treatment that has been identified as not working for that group of patients, then an alternate treatment regimen can be identified and provided. Outcome data also can be used to provide survival statistics and prognosis for a group of patients, which in turn can be provided as part of the personalized health information 28 of each patient that matches the characteristics of that group.

There are many kinds of personalized health information 28 that can be provided in this manner from the medical information for a patient.

As one example, the personalized health information 28 can include options for care given a patient's current condition and treatment regimen. In this case a computational model of the personalized information generation module 24 maps information from the patient profile 20 to the various options for care available for this patient. If the options for care require an appointment to visit a doctor, the personalized health information 28 may include the ability to schedule appropriate appointments.

As another example, the availability of clinical trials in which the patient can participate also can be part of the personalized health information 28. In this case the computational model of the personalized information generation module 24 can map data in the patient profile 20 to the inclusion and exclusion criteria of available clinical trials. If information for some of the criteria is not available, the personalized health information 28 for the patient may be augmented to include a prompt or other means for retrieving the missing information from either the patient or other caregiver (i.e., a prompt to link to a questionnaire can be provided with the personalized health information 28 that is provided through the portal). The missing information could require, for example, a laboratory test, and the personalized health information 28 for the patient could include a recommendation to the patient that the laboratory test be performed. The ability to schedule the laboratory test also can be provided. Such a system may be implemented in part using the system described in U.S. Patent Publication No. 2008/0033658, which is hereby incorporated by reference.

As another example, the personalized health information 28 can include drug treatment regimens related to a patient's current condition. In this case the computational model of the personalized information generation module 24 maps information from the patient profile 20 to the various drug treatments available for this patient. If the available drug treatments could be scheduled, or require an appointment to visit a doctor for a consultation, the personalized health information 28 may include the ability to schedule appropriate appointments.

As another example, the personalized health information 28 can include scheduling information for treatments already approved for the patient. In this case the computational model of the personalized information generation module 24 maps information from the patient profile 20, such as the approved treatment, to scheduling information for the facility providing the treatment.

As another example, especially for cancer patients, the personalized health information 28 can include survivorship data and a survivorship plan that is updated automatically and includes personalized data based on the patient's disease, previous treatment and other relevant characteristics. Such other characteristics may include a description of long-term and late effects of treatment, recommended surveillance test for late effects, when they should occur, and where they will be performed. Scheduling of appointments for such tests can be provided. Survivorship data can be accessed based on a patient's disease molecular profile (such as a tumor genetic profile) and corresponding treatment. In this example, the patient profile 20 can include tumor genetic profiles and treatments. The computational model of the personalized information generation module 24 can map tumor genetic profiles and treatment information to survivorship data and plans. Using the computational model, survivorship data and plans from similar patients can be processed to provide appropriate survivorship information to the patient. Because the plan is derived from the patient profile 20, it is a dynamic plan that is continually updated as the patient profile 20 changes and as other information used to derive the plan changes. In this example, such a system may be implemented in part using the system described in U.S. Patent Publication No. 2005/0256745, which is hereby incorporated by reference.

As another example, a patient may report symptoms. In this case, the personalized health information 28 may include recommendations for managing those symptoms (e.g., palliative care recommendations) in the context of the rest of the patient's medical condition, history and treatment regimen. In particular, the computational model of the personalized information generation module 24 can map the symptoms, along with other relevant information from the patient profile, such as current treatment regimen and other information about the patient's medical condition, to recommendations for managing symptoms. If the recommendations include, for example, some additional treatment or medicine, then the personalized health information for the patient could include a recommendation to the patient to pursue such treatment or take such medicine. Scheduling of appropriate treatments or appointments to obtain prescriptions can be provided.

As another example, the personalized health information 28 may include nutritional and/or rehabilitation and/or other lifestyle information or recommendations relevant to the patient's medical condition and treatment. In this example, the computational model for the personalized information generation model 24 can map information from the patient profile 20, such as the treatment regimen, symptoms, medical history, etc., to nutritional and rehabilitation recommendations specific to the patient. Notably, this information might be updated in response to other data provided by or about the patient during the course of treatment (such as through the response to a questionnaire).

As another example, the personalized health information 28 may include warning signs or adverse events to look out for that are relevant to the patient's medical condition and treatment. In this example, the computational model for the personalized information generation model 24 can map information from the patient profile 20, such as the treatment regimen, symptoms, medical history, etc., to known warning signs or adverse events that would indicate a deterioration or other change in the patient's condition that might require medical attention.

As another example, the personalized health information 28 may include information extracted from an electronic library, or links to information in an electronic library, that is most relevant to the patient's profile, given his/her disease, treatment, and other personal characteristics. In this case, the computational model can map information from the patient profile 20 to an electronic library, perhaps by using information from the patient profile 20 to perform a search on the electronic library, to provide links to information that the patient or a caregiver may find relevant. The electronic library may include the Internet, and/or indexed data from the Internet. The information that is highly relevant to a patient can be identified using a variety of concept mapping techniques, such as CMapTools Software from the Institute for Human and Machine Cognition (IHMC) for which documentation is provided at http://cmap.ihmc.us/documentation.

As another example, the computational model comprises concept maps for each patient derived from the patient profile 20 for each patient. The personalized information generation module 24 can search for and aggregate information from multiple information sources using the concept maps. A concept map is a technology developed by the Institute for Human and Machine Cognition. The Cmaps tool is a front end user interface that allows a user to more easily navigate a complex website. Concept maps are graphical tools for organizing and representing knowledge. They include concepts (e.g., enclosed in circles or boxes of some type) and relationships between concepts indicated by a connecting line linking two concepts. Words on the line, referred to as linking words or linking phrases, specify the relationship between the two concepts. In some implementations, a concept is defined as a perceived regularity in events or objects, or records of events or objects, designated by a label. In some implementations, the label is a word, although sometimes symbols such as + or %, or more than one word is used. Propositions are statements about some object or event in the universe, either naturally occurring or constructed. Propositions contain two or more concepts connected using linking words or phrases to form a meaningful statement. In some implementations, propositions are referred to as semantic units, or units of meaning. In some implementations, the concepts presented in a concept map are represented in a hierarchical fashion with the most inclusive, most general concepts at the top of the map and the more specific, less general concepts arranged hierarchically below. The hierarchical structure for a particular domain of knowledge also depends on the context in which that knowledge is being applied or considered. Concept maps are described in more detail on the web at http://cmap.ihmc.us/conceptmap.html. In some implementations, personalized information generation module 24 incorporates machine learning methodologies such that the a concept map (Cmap) interface is capable of learning from the user which paths are used more often and direct the presentation of content based on user preferences.

Returning to FIG. 7, at stage 710 display data associated with the personalized health information 28 is generated and returned to the user. The display data can be of the form of a webpage or document that is interactive leading to other pages or documents depending on navigation commands received from the user. Examples of such personalized display data are shown in FIGS. 5 and 6.

The method described in association with FIG. 7 is just one example of a method that can be used by the system to display patient centric information to a user of a networked device (e.g., through a portal). Another example method includes the following steps: extracting relevant information from a medical record for a patient; storing the relevant information in a patient profile separate from the medical record and accessible by a user of a networked device; generating, using the patient profile, a medical summary that includes a current medical condition and current treatment plan; generating a survivorship plan based on the patient profile detailing at least future diagnostic procedures to monitor the current condition; and presenting the medical summary and survivorship plan to the patient in a portal in response to a request received from the user of the networked device that includes a patient identifier and authenticating information.

In some implementations, the method can include one or more of the following additional features or steps. Extracting relevant information can include extracting information from a cancer registry. Extracting relevant information can include periodically evaluating the medical record for changes and extracting relevant information if changes are detected. Generating a medical summary can include periodically updating the medical summary based on receipt of new relevant information. In some implementations, the method includes evaluating the medical profile including mapping the medical profile to one or more decision trees and evaluating each decision tree to determine patient centric information; and providing the patient centric information in the portal to the user. Evaluating a decision tree can include determining if all information required to evaluate the decision tree is available, and if not, prompting the user to provide additional information. Prompting can include providing a questionnaire to the user and updating the patient profile to include information from the questionnaire.

Another example method for presenting patient centric information includes the following steps: extracting relevant information from a medical record for a patient; storing the relevant information in a patient profile separate from the medical record and accessible by a user of a networked device; augmenting the patient profile including generating patient centric information, the patient centric information including information that is not part of the medical record, the augmenting including mapping information from the patient profile to one or more templates and evaluating the templates to determine additional information to provide to the patient that is specific to one or more of their current condition, their current treatment, their past treatment, or their expected survival; storing the patient centric information in association with the patient profile; and presenting at least a portion of the profile and the patient centric information to the user in a portal in response to a request received from the user of the networked device that includes a patient identifier and authenticating information.

Yet another example method for presenting patient centric information includes the following steps: extracting information from a database, the extracted information forming a patient profile, the database maintained by an institution and including cancer registry information, the database being periodically updated with new information for both new and existing patients, the database also periodically being evaluated and used to update a local, regional, or national cancer registry not maintained by the institution; maintaining the patient profile separate from the database; generating a medical summary that includes a current medical condition and current treatment plan for a patient using the patient profile; and presenting the medical summary in a portal to a user of a networked device that has presented an identifier associated with the patient and authentication information.

The method can include one or more of the following additional features or steps. The method can include generating a survivorship plan detailing at least future diagnostic procedures for the patient and presenting the survivorship plan in the portal to the user. Presenting the medical summary can further include generating display data that includes the medical summary. The method can further include augmenting the patient profile including generating patient centric information, the patient centric information including information that is not part of the database, the augmenting including mapping information from the patient profile to one or more templates and evaluating the templates to determine additional information to provide to the patient that is specific to one or more of their current condition, their current treatment, their past treatment, or their expected survival.

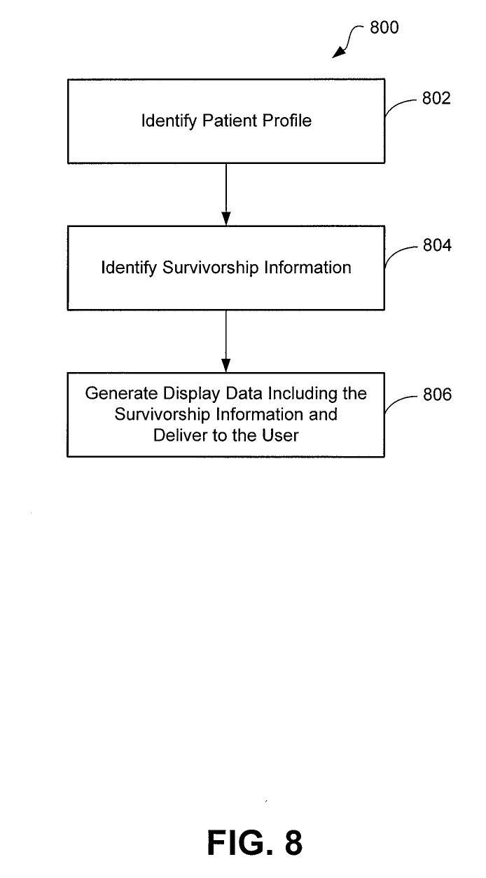

Referring now to FIG. 8, a method 800 is shown for presenting a survivorship plan to a user. At stage 802, a patient profile is identified. For example, the patient profile 20 can be identified based on a unique user identifier provided by a user. At stage 804, survivorship information can be identified. In some implementations, the survivorship information can include a survivorship plan. The survivorship plan can include follow-up plan details (i.e., future tests/observations to track recurrence of disease), specific information related to where patient is on a survivor timeline, supplemental information (e.g., things to watch out for in terms of particular side effects, long term effects, etc. based on the patient's ongoing or previous treatment) and other information. At stage 806, display data including the survivorship information is provided to a user.

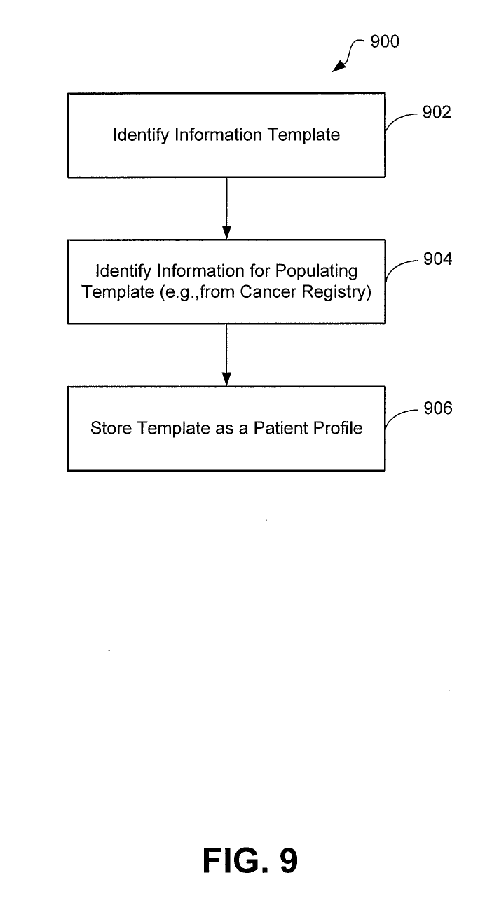

Referring now to FIG. 9, a method 900 for populating a patient profile with information is described. For example, the patient profile 20 can be populated with information from various sources, including information from an institutional cancer registry among other sources. At stage 902, an information template is identified for population of data. In some implementations, the template can be a virtual template that reflects a laundry list of information that is required to be assembled in order to complete a patient profile. The template can be unique to the patient, to the patient's underlying condition or conditions, to the type of treatment being offered or otherwise generalized or customized. At stage 904, information is identified for populating the information template. In some implementations, much of the information identified for populating the information template is derived from a cancer registry associated with an institution. The cancer registry can be of the form of an institutional database that includes records for each patient. The database can be updated periodically, and include an engine or control for reporting the registry information to one or more other institutions or agencies (e.g., reporting out records to a agency level registry such as the state of Florida's Cancer Registry). Examples of information that can be extracted from the cancer registry include patient name, date of birth, medical record number, age of diagnosis, patient contact information (e.g., address, phone number), support contact name, relationship and contact information, condition, site information (e.g., initial tumor site), family history, surgical history, pre-operation information (e.g., CEA Pre-op), diagnosis (e.g., cancer staging information including number of lymph nodes involved), comorbid condition information, treatment regiment information (e.g., chemotherapeutic agents administered), follow up information including disease recurrence information. This information and other information can be extracted from the cancer registry or from other systems (e.g., Cerner or Oncore Systems). Examples of other information can include list of pathology information, procedure list, patient weight (e.g., pre-treatment and current weight), body surface area (BSA), names of regimen associated with treatment program, disease status at last follow-up, date of last follow-up, date of next follow-up to name a few. At stage 906, the template information is stored in the form of a profile (e.g., patient profile 20).

The techniques and methods described above can be implemented using a combination of computer hardware and computer software. The techniques and methods can be implemented as a computer program product, i.e., computer program instructions encoded on or in a tangible computer-readable medium, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Each computer may implemented using one or more programmable processors executing a computer program to perform functions described herein by operating on input data and generating output, or using special purpose logic circuitry, e.g., an FPGA (field programmable gate array) or an ASIC (application-specific integrated circuit).

Processors suitable for the execution of a computer program include, by way of example, both general- and special-purpose microprocessors, and any one or more processors of any kind of digital computer. Generally, a processor will receive instructions and data from a read-only memory or a random access memory or both. The computer includes a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile computer memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A computer also may include a variety of input and output devices. Example input devices include but are not limited to a keyboard and a pointing device, such as a mouse, trackball, touchpad or the like. Example output devices include a display or monitor, audio outputs, and printing.

As shown in FIG. 1 the computing system can include client computers and a server. A client computer and server computer are generally remote from each other and typically interact over a communication network such as the Internet. The relationship of client and server arises by virtue of computer programs running on the respective computers and having a client-server relationship to each other.

Having described example embodiments, it should be apparent to those skilled in the art that the foregoing is merely illustrative and not limiting, having been presented by way of example only. Numerous modifications and other embodiments are with the scope of ordinary skill in the art and are contemplated as falling with the scope of the invention.

What is claimed is:

1. A computer system providing personalized health information for a plurality of patients, comprising;
a portal computer system connected to a computer network and receiving requests for information, wherein a request may include a unique identifier for at least one of a plurality of patients;
a database containing at least patient profiles for each of the plurality of patients, wherein each patient profile is accessible using the unique identifier associated with the corresponding patient and wherein each patient profile includes medical information for the patient;
a personalized information generation module having an input for receiving medical information from a patient profile for a patient and an output providing personalized health information for the patient according to the received medical information from the patient profile, the personalized health information including information that is relevant to the patient and not included in the patient's medical record; and
wherein the portal computer system further provides information, over the computer network, enabling access to the personalized health information for a patient, in response to a request for the personalized health information that includes the unique identifier for the patient.

2. The computer system of claim 1, wherein the output of the personalized information generation module is connected to the database and wherein the personalized health information is stored in the database.

3. The computer system of claim 1, wherein the output of the personalized information generation module is provided in response to the request received by the portal computer system.

4. The computer system of claim 1, wherein the personalized information generation module includes a computational model represented in computer software that accesses the medical information when the computer software is executed by a computer and maps the medical information for a patient to personalized health information for the patient.

5. The computer system of claim 4, wherein the computational model includes a decision tree represented in computer software that processes the medical information when the computer software is executed by a computer to provide the personalized health information.

6. The computer system of claim 1, wherein the database comprises clinical information systems including clinical data input by health care providers.

7. The computer system of claim 1, wherein the personalized health information comprises a survivorship plan, and wherein the survivorship plan is updated periodically in response to updates to the patient profile.

8. The computer system of claim 1, wherein the personalized health information is updated periodically in response to updates to the patient profile.

9. The computer system of claim 1, wherein the computational model comprises concept maps for each patient derived from the patient profile for each patient, and wherein the personalized information generation module searches and aggregates information from multiple information sources using the concept maps.

10. The computer system of claim 1, wherein the patient profile is generated substantially from information sources and not from the patient.

11. The computer system of claim 1 wherein the patient profile is generated substantially from an institutional cancer registry.

12. The computer system of claim 10, wherein the patient profile is generated using information substantially from clinical information systems including clinical data input by health care providers.

13. The computer system of claim 1, wherein the patient profile is generated using information substantially from clinical information systems including clinical data input by health care providers.

14. A computer system providing personalized health information for a plurality of patients, comprising;
a plurality of personal computer systems;
a portal computer system;
a computer network interconnecting the portal computer system and the plurality of personal computer systems
wherein the portal computer system receives, over the computer network, requests for information from the plurality of personal computer systems, wherein a request may include a unique identifier for at least one of a plurality of patients;
a database containing at least patient profiles for each of the plurality of patients, wherein each patient profile is accessible using the unique identifier associated with the corresponding patient and wherein each patient profile includes medical information for the patient;
a personalized information generation module having an input for receiving medical information from a patient profile for a patient and an output providing personalized health information for the patient according to the received medical information from the patient profile, the personalized health information including information that is relevant to the patient and not included in the patient's medical record; and
wherein the portal computer system further provides information, over the computer network, enabling at least one of the plurality of personal computer systems to access the personalized health information for a patient, in response to a request for the personalized health information that includes the unique identifier for the patient.

15. A method comprising:
extracting relevant information from a medical record for a patient;
storing the relevant information in a patient profile separate from the medical record and accessible by a user of a networked device;
generating using the patient profile a medical summary that includes a current medical condition and current treatment plan;
generating a survivorship plan based on the patient profile detailing at least future diagnostic procedures to monitor the current condition; and
presenting the medical summary and survivorship plan to the patient in a portal in response to a request received from the user of the networked device that includes a patient identifier and authenticating information.

16. The method of claim 15, wherein extracting relevant information includes extracting information from a cancer registry.

17. The method of claim 15, wherein extracting relevant information includes periodically evaluating the medical record for changes and extracting relevant information if changes are detected.

18. The method of claim 15, wherein generating a medical summary includes periodically updating the medical summary based on receipt of new relevant information.

19. The method of claim 15, further comprising
evaluating the medical profile including mapping the medical profile to one or more decision trees and evaluating each decision tree to determine patient centric information; and
providing the patient centric information in the portal to the user.

20. The method of claim 19, wherein evaluating a decision tree includes determining if all information required to evaluate the decision tree is available, and if not, prompting the user to provide additional information.

21. The method of claim 20, wherein prompting includes providing a questionnaire to the user and updating the patient profile to include information from the questionnaire.

22. A method comprising:
extracting relevant information from a medical record for a patient;
storing the relevant information in a patient profile separate from the medical record and accessible by a user of a networked device;
augmenting the patient profile including generating patient centric information, the patient centric information including information that is not part of the medical record, the augmenting including mapping information from the patient profile to one or more templates and evaluating the templates to determine additional information to provide to the patient that is specific to one or more of their current condition, their current treatment, their past treatment, or their expected survival;
storing the patient centric information in association with the patient profile; and
presenting at least a portion of the profile and the patient centric information to the user in a portal in response to a request received from the user of the networked device that includes a patient identifier and authenticating information.

23. A method comprising
extracting information from a database, the extracted information forming a patient profile, the database maintained by an institution and including cancer registry information, the database being periodically updated with new information for both new and existing patients, the database also periodically being evaluated and used to update a local, regional, or national cancer registry not maintained by the institution;
maintaining the patient profile separate from the database;
generating a medical summary that includes a current medical condition and current treatment plan for a patient using the patient profile; and
presenting the medical summary in a portal to a user of a networked device that has presented an identifier associated with the patient and authentication information.

24. The method of claim 23, further comprising generating a survivorship plan detailing at least future diagnostic procedures for the patient and presenting the survivorship plan in the portal to the user.

25. The method of claim 23, wherein presenting the medical summary further includes generating display data that includes the medical summary.

26. The method of claim 23, further comprising augmenting the patient profile including generating patient centric information, the patient centric information including information that is not part of the database, the augmenting including mapping information from the patient profile to one or more templates and evaluating the templates to determine additional information to provide to the patient that is specific to one or more of their current condition, their current treatment, their past treatment, or their expected survival.
